(19) United States
(12) Patent Application Publication
(10) Pub. No.: US 2023/0330793 A1
(43) Pub. Date: Oct. 19, 2023

(54) ENGAGEMENT COMPONENT SUPPLYING APPARATUS

(71) Applicants: HYUNDAI MOTOR COMPANY, Seoul (KR); KIA CORPORATION, Seoul (KR)

(72) Inventors: Jongmin Park, Ulsan (KR); Jung Pyo Kim, Ulsan (KR); Woojong Kim, Ulsan (KR); Junhyeok Bae, Ulsan (KR)

(73) Assignees: HYUNDAI MOTOR COMPANY, Seoul (KR); KIA CORPORATION, Seoul (KR)

(21) Appl. No.: 17/874,027

(22) Filed: Jul. 26, 2022

(30) Foreign Application Priority Data
Apr. 15, 2022 (KR) 10-2022-0046972

(51) Int. Cl. B23P 19/06

(52) U.S. Cl. CPC B23P 19/06; B62D 65/02

(57) ABSTRACT

An engagement component supplying apparatus includes: i) a jig frame in which at least one driving unit is installed and which is configured to support an engagement target part and a corresponding part to be engaged each other through a plurality of engagement components; ii) an engagement component picking unit installed on the at least one driving unit through a mounting bracket and which is configured to pick the plurality of engagement components aligned at a predetermined position; and iii) an engagement component temporary engagement unit installed on the mounting bracket and which is configured to, while picking the plurality of engagement components picked by the engagement component picking unit one by one, temporarily engage the plurality of engagement components to a plurality of second engagement portions of the corresponding part through a plurality of first engagement portions of the engagement target part.

### CROSS-REFERENCE TO RELATED APPLICATION

This application claims priority to and the benefit of Korean Patent Application No. 10-2022-0046972 filed in the Korean Intellectual Property Office on Apr. 15, 2022, the entire contents of which are incorporated herein by reference.

### BACKGROUND

### (a) Technical Field

An embodiment of the present disclosure relates to an engagement component supplying apparatus. More particularly, the present disclosure relates to an engagement component supplying apparatus for supplying a plurality of engagement components, such as a plurality of bolts, to a predetermined position.

### (b) Description of the Related Art

In general, a plurality of engagement components including a bolt and a nut are representative as a mechanical element for coupling two or more components. Such a plurality of engagement components is used in various industry fields including vehicle manufacturing.

In the process of assembling assembly components of a vehicle, an engagement target part is engaged to a corresponding part using the plurality of engagement components (e.g., a plurality of bolts or the like) (hereinafter, referred to as a plurality of bolts).

In this process, the plurality of bolts is loaded into bolt holes of the engagement target part through an engagement component supplying apparatus. The plurality of bolts is engaged to the corresponding part through an engagement component engaging tool.

However, when the thickness of the engagement target part is thin or the diameter of the bolt holes of the engagement target part is larger than the outer diameter of the plurality of bolts, the plurality of bolts may be unstably loaded into the bolt holes. This may cause deteriorated assembly productivity and assembly quality of the assembly components.

The above information disclosed in this Background section is only to enhance understanding of the background of the disclosure. Therefore, the Background section may contain information that does not form the conventional art that is already known in this country to a person of ordinary skill in the art.

### SUMMARY

Embodiments of the present disclosure have been made in an effort to solve the above issue and provide an engagement component supplying apparatus. The engagement component supplying apparatus is capable of supplying an engagement target part and a corresponding part to be engaged to each other with a plurality of engagement components at a high speed and a stable posture.

An embodiment of the present disclosure provides an engagement component supplying apparatus, i.e., a supplying apparatus. The supplying apparatus includes a jig frame in which at least one driving unit is installed and which is configured to support an engagement target part and a corresponding part to be engaged to each other through a plurality of engagement components. The supplying apparatus further includes an engagement component picking unit installed on the at least one driving unit through a mounting bracket. The engagement component picking unit is configured to pick the plurality of engagement components aligned at a predetermined position. The supplying apparatus also includes an engagement component temporary engagement unit installed on the mounting bracket. The engagement component temporary engagement unit is configured to, while picking the plurality of engagement components picked by the engagement component picking unit one by one, temporarily engage the plurality of engagement components to a plurality of second engagement portions of the corresponding part through a plurality of first engagement portions of the engagement target part.

Further, the engagement component supplying apparatus, according to an embodiment of the present disclosure, may further include an engagement component alignment unit coupled to the jig frame. The engagement component alignment unit may be configured to align the plurality of engagement components at a predetermined position.

Further, in the engagement component supplying apparatus, according to an embodiment of the present disclosure, the engagement component alignment unit may include at least one parts feeder configured to feed the plurality of engagement components along a predetermined path. The engagement component alignment unit may also include an engagement component index connected to the at least one parts feeder and configured to align the plurality of engagement components.

Further, in the engagement component supplying apparatus, according to an embodiment of the present disclosure, the engagement component index may include a ring-shaped fixing member connected to a line feeder of the at least one parts feeder. The engagement component index may further include a disk-shaped rotating member rotatably installed on the fixing member by a servo motor. The disk-shaped rotating member has a plurality of engagement component alignment grooves connected to the line feeder formed on its edge to be spaced apart from each other.

Further, in the engagement component supplying apparatus, according to an embodiment of the present disclosure, the at least one driving unit may include a plurality of rails extending in a front-rear direction, a left-right direction, and a vertical direction, respectively.

Further, in the engagement component supplying apparatus, according to an embodiment of the present disclosure, the mounting bracket may be installed movably in the vertical direction on one rail.

Further, in the engagement component supplying apparatus, according to an embodiment of the present disclosure, the one rail may be installed movably in the left-right direction on another rail.

Further, in the engagement component supplying apparatus, according to an embodiment of the present disclosure, the other rail may be installed movably in the front-rear direction on a pair of other rails.

Further, in the engagement component supplying apparatus, according to an embodiment of the present disclosure, the engagement component picking unit may include a disk-shaped magazine plate rotatably installed on the mounting bracket and may include a plurality of picking socket members mounted at least in a row to be spaced apart from each other on the magazine plate along its edge.

Further, in the engagement component supplying apparatus, according to an embodiment of the present disclosure, the magazine plate may include a plurality of socket mounting holes formed to be spaced apart from each other at least in a row along its edge.

Further, in the engagement component supplying apparatus, according to an embodiment of the present disclosure, each of the plurality of picking socket members may be mounted in each of the plurality of socket mounting holes and may have a socket hole formed in a vertical direction.

Further, in the engagement component supplying apparatus, according to an embodiment of the present disclosure, each of the plurality of picking socket members may include a socket body portion having a cylindrical shape and which is inserted into each of the plurality of socket mounting holes in a vertical direction and in which a socket hole is formed. Each of the plurality of picking socket members may further include a socket fixing portion integrally connected to the top of the socket body portion and fixed to an upper surface of the magazine plate.

Further, in the engagement component supplying apparatus, according to an embodiment of the present disclosure, the engagement component picking unit may be provided in a ring shape and may further include a first magnet member fixed to an inner circumferential surface of each of the plurality of picking socket members.

Further, in the engagement component supplying apparatus, according to an embodiment of the present disclosure, the engagement component temporary engagement unit may include a moving member installed movably in a vertical direction on the mounting bracket, a runner body rotatably installed on the moving member, and a runner socket member installed on the runner body so as to penetrate each of the plurality of picking socket members in the vertical direction.

Further, in the engagement component supplying apparatus, according to an embodiment of the present disclosure, the engagement component temporary engagement unit may further include a second magnet member installed inside the runner socket member.

Further, in the engagement component supplying apparatus, according to an embodiment of the present disclosure, the at least one driving unit may include a handling robot.

Further, in the engagement component supplying apparatus, according to an embodiment of the present disclosure, the plurality of engagement components may include a plurality of bolts.

According to embodiments of the present disclosure, it is possible to supply an engagement target part and its corresponding part to be engaged to each other with a plurality of engagement components at a high speed and a stable posture, thereby improving the assemble productivity and assembly quality of assembly components.

Except for this, effects obtainable or predicted by an embodiment of the present disclosure are to be disclosed directly or implicitly in the detailed description of embodiments of the present disclosure. In other words, various effects predicted according to an embodiment of the present disclosure are disclosed in the detailed description below.

### BRIEF DESCRIPTION OF THE DRAWINGS

Since these drawings are for reference in describing embodiments of the present disclosure, the technical idea of the present disclosure should not be construed as being limited to the accompanying drawings.

FIG. 1 is a perspective view illustrating an engagement component supplying apparatus according to an embodiment of the present disclosure.

FIG. 2 is a top plan view illustrating an engagement component supplying apparatus according to an embodiment of the present disclosure.

FIG. 3 is a front view illustrating an engagement component supplying apparatus according to an embodiment of the present disclosure.

FIG. 4 is a diagram schematically illustrating an example of an assembly component applicable to an engagement component supplying apparatus according to an embodiment of the present disclosure.

FIG. 5 and FIG. 6 are diagrams illustrating an engagement component alignment unit applied to an engagement component supplying apparatus according to an embodiment of the present disclosure.

FIG. 7 and FIG. 8 are perspective views illustrating an engagement component picking unit and an engagement component temporary engagement unit applied to an engagement component supplying apparatus according to an embodiment of the present disclosure.

FIG. 9 and FIG. 10 are diagrams illustrating an engagement component picking unit applied to an engagement component supplying apparatus according to an embodiment of the present disclosure.

FIG. 11 and FIG. 12 are diagrams illustrating an engagement component temporary engagement unit applied to an engagement component supplying apparatus according to an embodiment of the present disclosure.

FIGS. 13-16 are diagrams for explaining an operation of an engagement component supplying apparatus according to an embodiment of the present disclosure.

FIG. 17 is a diagram schematically illustrating an exemplary variation of a driving unit applied to an engagement component supplying apparatus according to an embodiment of the present disclosure.

It is to be understood that the drawings referenced above are not necessarily drawn to scale, but rather present simplified representations of various features illustrating the basic principles of the present disclosure. For example, certain design features of the present disclosure, including particular size, direction, position, and shape, are determined in part by the particular intended application and environment of use.

### DETAILED DESCRIPTION OF THE EMBODIMENTS

The present disclosure is described more fully hereinafter with reference to the accompanying drawings, in which embodiments of the disclosure are shown. Those of ordinary skill in the art would realize, the described embodiments may be modified in various different ways, all without departing from the spirit or scope of the present inventive concept.

The drawings and description are to be regarded as illustrative in nature and not restrictive Also, like reference numerals designate like elements throughout the specification.

Since the size and thickness of each component shown in the drawings are arbitrarily indicated for convenience of description, the present disclosure is not necessarily limited to the drawings In some cases, the thickness may be enlarged to clearly express various parts and regions.

Further, terms such as “first,” “second,” and the like for distinguishing components are used to denote components of the same feature and distinguish one component from another component. In the following detailed description, the present disclosure is not necessarily limited to the order.

Throughout the specification, when a part comprises constituent elements, this means that other constituent elements may be further included, rather than excluding other constituent elements, unless otherwise stated.

In addition, terms such as “unit,” “part,” and “member,” which are described in the specification, mean a unit of a comprehensive configuration that performs at least one function or operation.

The terminology used herein is for the purpose of describing particular embodiments only and is not to be limiting of the embodiments. As used herein, the singular forms are intended to include the plural forms as well, unless the context clearly indicates otherwise.

It should be further understood that the terms “includes,” “including,” “comprises,” and/or “comprising,” when used in this specification, specify the presence of stated features, integers, steps, operations, constituent elements, and/or components, but do not preclude the presence or addition of one or more other features, integers, steps, operations, constituent elements, components, and/or groups thereof. As used herein, the term “and/or” includes any one or all combination of any two or more of the associated listed items.

As used herein, the term “coupled” specifies a physical relationship between two components in which the components are directly connected to each other or indirectly connected through at least one intermediate component.

Furthermore, as used herein, the term “operably connected” or a similar term means that at least two members are directly or indirectly connected to each other to transmit power. However, two operatively connected members do not always rotate at the same speed and in the same direction.

Furthermore, as used herein, the term “vehicle,” “of a vehicle,” “automobile” or another similar term generally refers to passenger vehicles. Passenger vehicles may include sports utility vehicles (SUVs), hybrid electric vehicles, electric vehicles, plug-in hybrid electric vehicles, hydrogen power vehicles, and vehicles of other alternative fuels (e.g., fuel obtained from resources other than petroleum).

Hereinafter, embodiments of the present disclosure are described in detail with reference to the accompanying drawings.

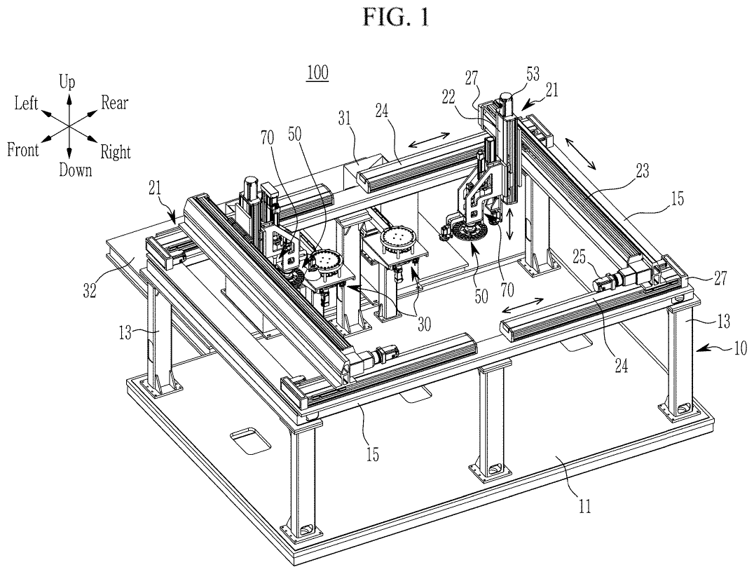

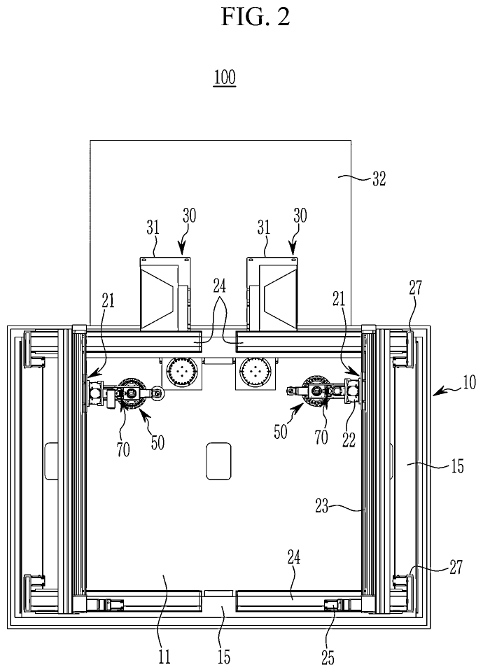

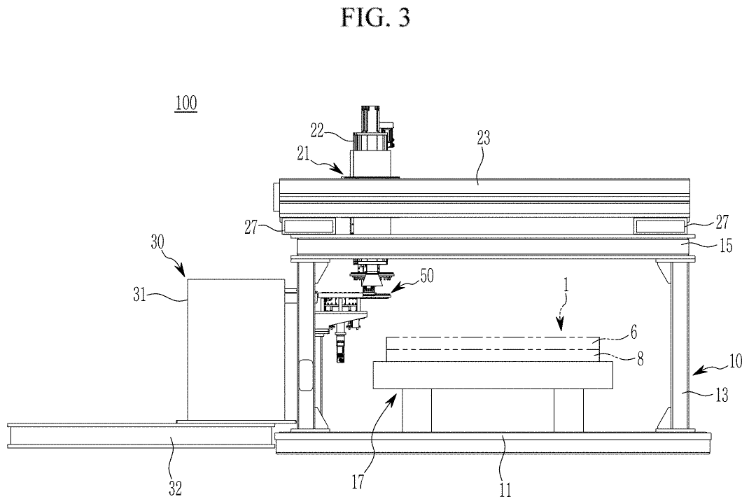

FIG. 1 is a perspective view showing an engagement component supplying apparatus according to an embodiment of the present disclosure. FIG. 2 is a top plan view showing the engagement component supplying apparatus according to an embodiment of the present disclosure. FIG. 3 is a front view showing the engagement component supplying apparatus according to an embodiment of the present disclosure.

Referring to FIGS. 1-3, an engagement component supplying apparatus 100, according to an embodiment of the present disclosure, may be applied to a process of assembling various assembly components 1 that may be mounted on a vehicle body in a vehicle manufacturing factory.

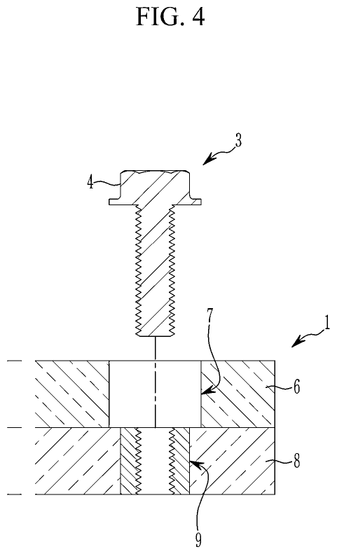

For example, the engagement component supplying apparatus 100, according to an embodiment of the present disclosure, may be applied to a process of engaging various assembly components 1 through a plurality of engagement components 3 as shown in FIG. 4.

The plurality of engagement components 3 may include a plurality of bolts 4 and a plurality of nuts (not shown) known to a person of ordinary skill in the art. However, according to embodiments of the present disclosure, the plurality of engagement components 3 may be a plurality of bolts 4 or other fastener types.

The various assembly components 1 may include, in one example, chassis components such as an engine, a transmission, and a suspension. In another example, the various assembly components 1 may include an electrical system such as a battery system assembly, a fuel cell stack assembly, and a power electric (PE) module (e.g., a drive motor, a reducer, an inverter, and the like).

Such various assembly components 1 may include an engagement target part 6 and a corresponding part 8 that may be engaged to each other by a plurality of bolts 4.

In one example, when the various assembly components 1 are engines, the engagement target part 6 may be a head cover and the corresponding part 8 may be a cylinder block. In another example, when the various assembly components 1 are a battery system assembly, the engagement target part 6 may be a battery pack assembly and the corresponding part 8 may be a battery case.

The engagement target part 6 may include a plurality of first engagement portions 7 in which the plurality of bolts 4 are inserted. In one example, each of the plurality of first engagement portions 7 may include a bolt hole.

The corresponding part 8 may include a plurality of second engagement portions 9 with which a plurality of bolts 4 are engaged through the plurality of first engagement portions 7. In one example, each of the plurality of second engagement portions 9 may include a nut known to a person of ordinary skill in the art (e.g., a pipe nut or a weld nut). The plurality of second engagement portions 9 are connected to the plurality of first engagement portions 7.

In the present specification, the following constituent elements are described with reference to the front-rear direction, the left-right direction, and the vertical direction.

Further, in this specification, a “top part,” “upper part,” “top,” or “upper surface” of a constituent element indicates an end part, part, end, or face of the constituent element that is relatively upper in the drawing. Further, a “bottom part,” “lower part,” “bottom,” or “lower surface” of a constituent element indicates an end part, part, end, or face of the constituent element that is relatively lower in the drawing.

Furthermore, in the present specification, an end of a constituent element (e.g., one end or the other end) indicates an end of the constituent element in any one direction. An end part of a constituent element (e.g., one end or the other end) indicates a portion of the constituent element including the end.

The engagement component supplying apparatus 100, according to an embodiment of the present disclosure, may supply the plurality of bolts 4 to the plurality of first engagement portions 7 and the plurality of second engagement portions 9 connected to each other at high speed.

In addition, the engagement component supplying apparatus 100, according to an embodiment of the present disclosure, may supply the plurality of bolts 4 to the plurality of first engagement portions 7 and the plurality of second engagement portions 9 connected to each other in a stable posture (e.g., an upright posture).

For this, the engagement component supplying apparatus 100, according to an embodiment of the present disclosure, includes a jig frame 10, an engagement component alignment unit 30, an engagement component picking unit 50, and an engagement component temporary engagement unit 70.

In an embodiment of the present disclosure, the jig frame 10 is installed on the floor of a process workshop. At least one driving unit 21 is installed in the jig frame 10.

The jig frame 10 includes a base frame 11, a plurality of vertical frames or frame elements 13, and a plurality of horizontal frames or frame elements 15.

The base frame 11 is provided in a plate type and fixed to the floor of the process workshop. The plurality of vertical frames 13 are coupled to an upper surface of the base frame 11 and extend upward.

In addition, the plurality of horizontal frames 15 are disposed in the horizontal direction, relative to the plurality of vertical frames 13. Each of the plurality of horizontal frames 15 are coupled to the top of the plurality of vertical frames 13. The plurality of horizontal frames 15 are disposed along the front-rear direction and the left-right direction.

The jig frame 10 is provided with a part supporting portion 17. The part supporting portion 17 is provided to support the engagement target part 6 and the corresponding part 8 to be engaged to each other. The part supporting portion 17 is provided in a pallet type known to a person of ordinary skill in the art and is disposed on the upper surface of the base frame 11.

Further, the at least one driving unit 21 is provided to move the engagement component picking unit 50 and the engagement component temporary engagement unit 70 reciprocally in the front-rear direction, the left-right direction, and the vertical direction. In one example, the at least one driving unit 21 may be provided as a triaxial orthogonal robot.

The at least one driving unit 21 includes a plurality of rails 22, 23, and 24, respectively extending in the front-rear direction, the left-right direction, and the vertical direction. The plurality of rails 22, 23, and 24 are disposed on the plurality of horizontal frames 15. In one example, the at least one driving unit 21 may be provided with four rails 22, 23, and 24 (e.g., a pair of other rails).

In this example, one rail 22 is disposed in the vertical direction through the other rail 23. The other rail 23 is disposed in the left-right direction on the plurality of horizontal frames 15. In addition, a pair of other rails 24 are disposed in the front-rear direction on the plurality of horizontal frames 15.

Furthermore, the one rail 22 is installed on the other rail 23 to be reciprocally movable in the left-right direction. Further, the other rail 23 is installed on the other pair of rails 24 to be reciprocally movable in the front-rear direction.

For this, the one rail 22 is operationally connected to a first servo motor 25 provided on the other rail 23. Further, the other rail 23 is operationally connected to a second servo motor 27 provided on the other pair of rails 24, respectively.

The at least one driving unit 21, as described above, may be provided as a pair in one example. Each of the pair of driving units 21 may be installed in the front and rear portions of the plurality of horizontal frames 15.

In an embodiment of the present disclosure, the engagement component alignment unit 30 is configured to align the plurality of bolts 4 engaging the engagement target part 6 and the corresponding part 8 at a predetermined position in a predetermined posture.

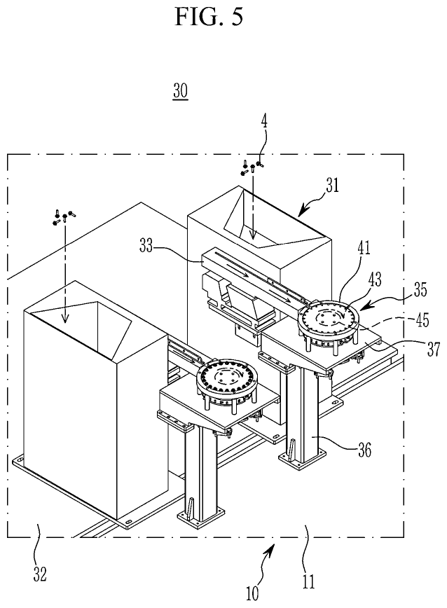

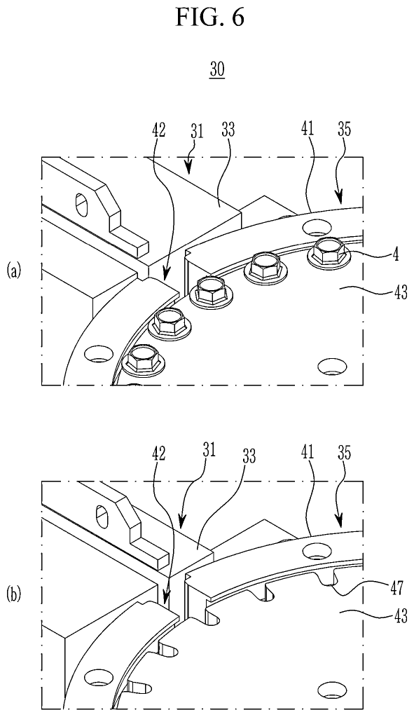

FIG. 5 and FIG. 6 are diagrams illustrating an engagement component alignment unit applied to the engagement component supplying apparatus according to an embodiment of the present disclosure.

Referring to FIGS. 1-6, the engagement component alignment unit 30 is coupled to the base frame 11 of the jig frame 10. The engagement component alignment unit 30 includes at least one parts feeder 31 and an engagement component index 35.

The at least one parts feeder 31 is configured to feed the plurality of bolts 4 by a vibrational force and to input or feed the plurality of bolts 4 randomly along a predetermined path. The at least one parts feeder 31 is installed on a feeder frame 32 coupled to the base frame 11.

The at least one parts feeder 31 includes a line feeder 33. The line feeder 33 is provided in a straight line shape. The line feeder 33 transfers the plurality of bolts 4 in the straight line direction (e.g., the left-right direction) and is configured to arrange them in a predetermined posture (e.g., in an upright position with the head facing up).

In one example, the at least one parts feeder 31 may be provided as a pair. Each of the pair of parts feeders 31 may be disposed at a position corresponding to each of the pair of driving units 21.

The engagement component index 35 is configured to align the plurality of bolts 4 transferred in a predetermined posture along the line feeder 33 to be spaced apart along a circular track at a predetermined interval. The engagement component index 35 is installed on a post 36 mounted in the vertical direction on the upper surface of the base frame 11. The engagement component index 35 is installed on the top of the post 36 through a mounting plate 37.

The engagement component index 35 is connected to the line feeder 33 of the at least one parts feeder 31. The engagement component index 35 includes a fixing member 41 and a rotating member 43.

The fixing member 41 is fixed to the mounting plate 37 and connected to the line feeder 33. The fixing member 41 is disposed to be spaced apart from an upper surface of the mounting plate 37. In one example, the fixing member 41 may be provided in a ring shape. The fixing member 41 includes a connection groove 42 connected to the line feeder 33.

The rotating member 43 is disposed inside the fixing member 41 and is rotatably installed on the mounting plate 37. The rotating member 43 is operably connected to a third servo motor 45 installed on the mounting plate 37.

In one example, the rotating member 43 may be provided in a disk shape. The rotating member 43 includes a plurality of engagement component alignment grooves 47 formed on its edge to be spaced apart from each other.

The plurality of engagement component alignment grooves 47 are configured to align the plurality of bolts 4 upright in the vertical direction through the inner circumferential surface of the fixing member 41. Each of the plurality of engagement component alignment grooves 47 may be selectively connected to the line feeder 33 through the connection groove 42 of the fixing member 41.

The rotating member 43 may support the heads of the plurality of bolts 4 aligned in each of the plurality of engagement component alignment grooves 47 through the upper surface.

Referring to FIGS. 1-4, in an embodiment of the present disclosure, the engagement component picking unit 50 is configured to pick the plurality of bolts 4 aligned at a predetermined position by the engagement component alignment unit 30.

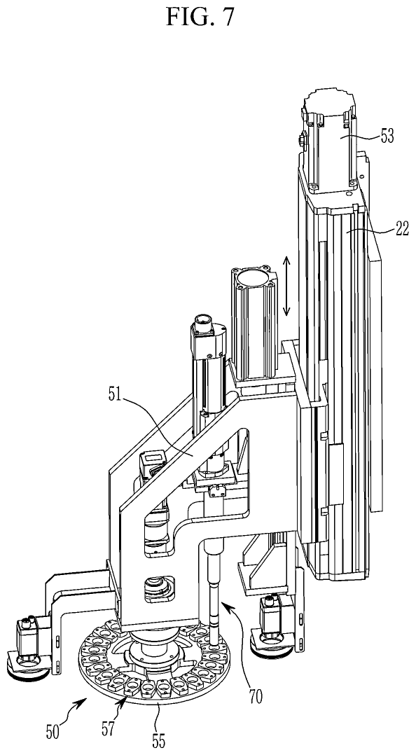

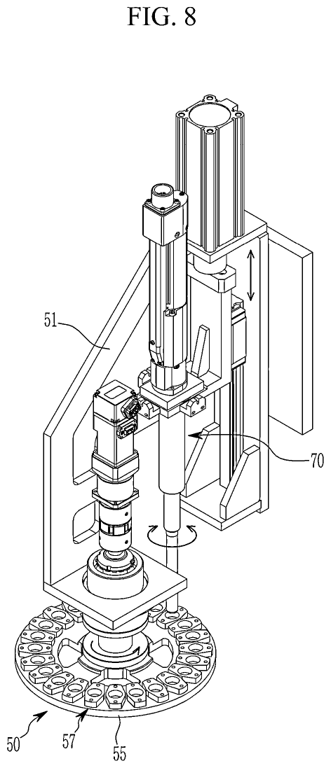

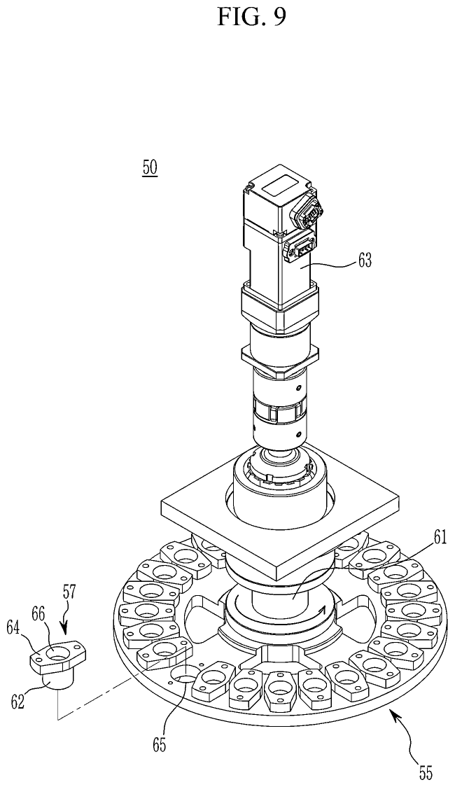

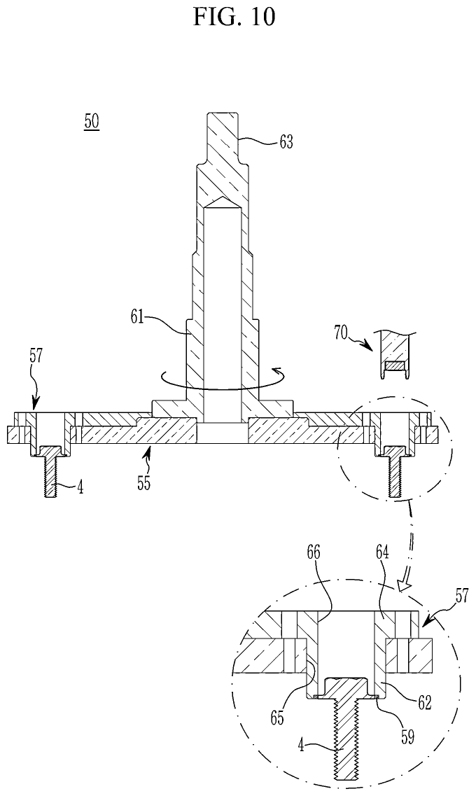

FIG. 7 and FIG. 8 are perspective views illustrating an engagement component picking unit and an engagement component temporary engagement unit applied to the engagement component supplying apparatus according to an embodiment of the present disclosure. FIG. 9 and FIG. 10 are diagrams illustrating the engagement component picking unit applied to the engagement component supplying apparatus according to an embodiment of the present disclosure.

Referring to FIGS. 7-10, the engagement component picking unit 50, according to an embodiment of the present disclosure, is installed with the engagement component temporary engagement unit 70 on the at least one driving unit 21 through a mounting bracket 51 (hereinafter, see FIG. 1).

The mounting bracket 51 is installed movably in the vertical direction on one rail 22 of the at least one driving unit 21. The mounting bracket 51 is operably connected to a fourth servo motor 53 provided on one rail 22.

In other words, the engagement component picking unit 50 and the engagement component temporary engagement unit 70, according to an embodiment of the present disclosure, may be reciprocally moved respectively in the front-back direction, the left-right direction, and the vertical direction through the mounting bracket 51 by the at least one driving unit 21.

The engagement component picking unit 50, according to an embodiment of the present disclosure, includes a magazine plate 55, a plurality of picking socket members 57, and a first magnet member 59.

The magazine plate 55 is rotatably installed on the mounting bracket 51. In one example, the magazine plate 55 may be provided in a disk shape.

The magazine plate 55 is connected to a rotation shaft 61 disposed in the vertical direction. The rotation shaft 61 is rotatably installed on the mounting bracket 51 and is operably connected to a fifth servo motor 63 fixed to the mounting bracket 51.

The magazine plate 55 includes a plurality of socket mounting holes 65 formed at least in a row to be spaced apart from each other along its edge.

Alternatively, the plurality of socket mounting holes 65 may be formed in two or more rows on the magazine plate 55 according to the quantity of the plurality of bolts 4 and according to the specifications of the engagement target part 6 (hereinafter, see FIG. 4) and the corresponding part 8 (hereinafter, see FIG. 4).

The plurality of picking socket members 57 are provided to substantially pick the plurality of bolts 4 aligned by the engagement component alignment unit (hereinafter, see FIG. 5 and FIG. 6). Each of the plurality of picking socket members 57 are mounted in each of the plurality of socket mounting holes 65 of the magazine plate 55. In other words, the plurality of picking socket members 57 are disposed at least in a row to be spaced apart from each other on the magazine plate 55 along its edge. Each of the plurality of picking socket members 57 includes a socket body portion 62 and a socket fixing portion 64.

The socket body portion 62 is provided in a cylindrical shape and is inserted into the plurality of socket mounting holes 65 in the vertical direction. The socket body portion 62 includes a socket hole 66 penetrating in the vertical direction.

The socket fixing portion 64 is integrally connected to the top of the socket body portion 62 and fixed to an upper surface of the magazine plate 55. In one example, the socket fixing portion 64 may be bolt-engaged to the upper surface of the magazine plate 55.

The first magnet member 59 is provided in a ring shape and fixed to an inner circumferential surface of the socket body portion 62. The first magnet member 59 may fix head edge portions of the plurality of bolts 4 to the inner circumferential surface of the socket body portion 62 by magnetic force.

Referring to FIGS. 1-4 and FIGS. 7-10, in an embodiment of the present disclosure, the engagement component temporary engagement unit 70 is configured to pick the plurality of bolts 4, picked by the engagement component picking unit 50, one by one.

The engagement component temporary engagement unit 70 may pick a plurality of bolts 4, picked by the engagement component picking unit 50, one by one while moving in the vertical direction. In other words, in a state in which the magazine plate 55 of the engagement component picking unit 50 is rotated by an interval of the plurality of picking socket members 57, the engagement component temporary engagement unit 70 may pick the plurality of bolts 4 one by one penetrating the plurality of picking socket members 57.

Furthermore, the engagement component temporary engagement unit 70 is configured to engage the plurality of bolts 4 to the second engagement portions 9 of the corresponding part 8 through the plurality of first engagement portions 7 of the engagement target part 6, while picking them one by one.

The engagement component temporary engagement unit 70 is installed on the mounting bracket 51 to correspond to the engagement component picking unit 50.

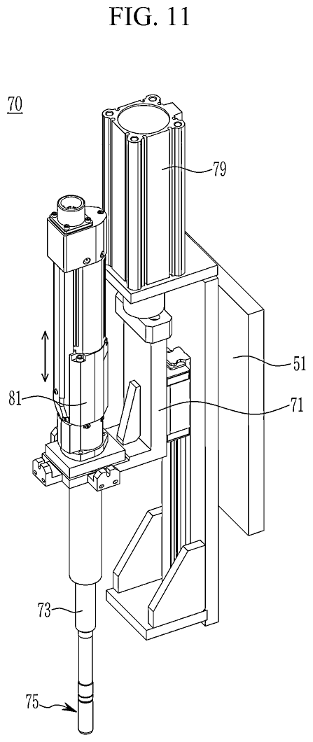

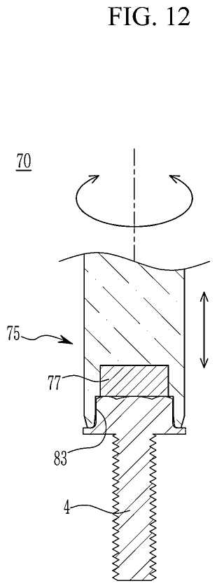

FIG. 11 and FIG. 12 are diagrams illustrating an engagement component temporary engagement unit applied to the engagement component supplying apparatus according to an embodiment of the present disclosure.

Referring to FIG. 7, FIG. 8, FIG. 11, and FIG. 12, the engagement component temporary engagement unit 70, according to an embodiment of the present disclosure, includes a moving member 71, a runner body 73, a runner socket member 75, and a second magnet member 77.

The moving member 71 is installed on the mounting bracket 51 to be reciprocally movable in the vertical direction. The moving member 71 is operably connected to a sixth servo motor 79 fixed to the mounting bracket 51.

The runner body 73 is rotatably installed on the moving member 71 and disposed along the vertical direction. The runner body 73 may be provided in a nut runner type, and may be rotated by an air motor 81 known to a person of ordinary skill in the art.

The runner socket member 75 is configured to pick the plurality of bolts 4 picked by each of the plurality of picking socket members 57, while penetrating each of the plurality of picking socket members 57 of the engagement component picking unit 50 in the vertical direction. The runner socket member 75 is mounted on a lower portion of the runner body 73.

The runner socket member 75 is provided in a cylindrical shape. An engagement component fixing groove 83 configured to fix the heads of the plurality of bolts 4 is formed on a lower portion of the runner socket member 75.

Further, the second magnet member 77 is installed inside the runner socket member 75. The second magnet member 77 may fix the heads of the plurality of bolts 4 picked by each of the plurality of picking socket members 57.

Hereinafter, an operation of the engagement component supplying apparatus 100, according to an embodiment of the present disclosure, configured as described above, is described in detail with reference to FIGS. 1-12 and the accompanying description.

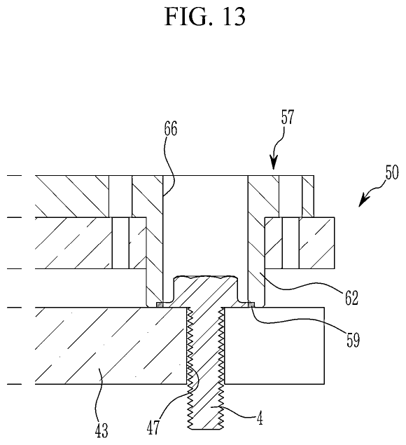

FIGS. 13-16 are diagrams explaining the operation of the engagement component supplying apparatus according to an embodiment of the present disclosure.

First, the engagement target part 6 and the corresponding part 8, to be engaged to each other, are transferred to the jig frame 10 by a transfer apparatus known to a person of ordinary skill in the art. Then, in the jig frame 10, the engagement target part 6 and the corresponding part 8 are loaded on the part supporting portion 17 on the base frame 11.

The engagement target part 6 and the corresponding part 8 are abutted. In addition, the plurality of first engagement portions 7 of the engagement target part 6 and the plurality of second engagement portions 9 of the corresponding part 8 are interconnected.

In this process, the plurality of bolts 4, randomly input to the at least one parts feeder 31, are aligned upright in the vertical direction through the line feeder 33 and transferred to the engagement component index 35 along the straight line direction.

Then, the plurality of bolts 4 are fitted into one of the plurality of engagement component alignment grooves 47 of the rotating member 43 through the connection groove 42 of the fixing member 41 to be aligned.

Therefore, when the rotating member 43 continues to rotate at a predetermined rotation angle, the plurality of bolts 4 may be aligned along a circular orbit in the plurality of engagement component alignment grooves 47 of the rotating member 43. The rotating member 43 supports the heads of the plurality of bolts 4 aligned in each of the plurality of engagement component alignment grooves 47 through the upper surface.

In this state, the engagement component picking unit 50 and the engagement component temporary engagement unit 70 are moved in the front-back direction, the left-right direction, and the vertical direction by the at least one driving unit 21.

Then, the magazine plate 55 of the engagement component picking unit 50 is positioned above the rotating member 43 (a position spaced apart by a predetermined distance upward from the rotating member). At this time, the engagement component temporary engagement unit 70 has been moved in the upward direction.

Then, the engagement component picking unit 50 is moved in the downward direction together with the engagement component temporary engagement unit 70 by the at least one driving unit 21.

Accordingly, as shown in FIG. 13, the plurality of bolts 4 aligned in the plurality of engagement component alignment grooves 47 of the rotating member 43 are inserted into the plurality of picking socket members 57 of the engagement component picking unit 50 in the vertical direction.

Each of the plurality of bolts 4 is inserted into the socket hole 66 of the socket body portion 62 of each of the plurality of picking socket members 57 in the vertical direction. Each of the plurality of bolts 4 is fixed to the inner circumferential surface of the socket body portion 62 by magnetic force of the first magnet member 59.

Then, the engagement component picking unit 50 is moved in the upward direction together with the engagement component temporary engagement unit 70 by the at least one driving unit 21.

Accordingly, while the plurality of bolts 4 are fixed to the inner circumferential surface of the socket body portion 62 through the first magnet member 59, the plurality of bolts 4 escape (e.g., move, transfer, separate, or the like) in the upward direction from the plurality of engagement component alignment grooves 47 of the rotating member 43.

Next, the engagement component picking unit 50 is moved in the front-rear direction, the left-right direction, and the vertical direction together with the engagement component temporary engagement unit 70 by the at least one driving unit 21.

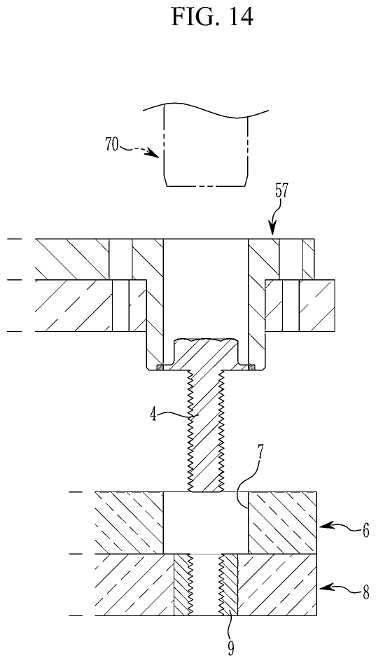

Then, as shown in FIG. 14, one of the plurality of bolts 4, picked in the plurality of picking socket members 57, is positioned above one of the plurality of first engagement portions 7 and one of the plurality of second engagement portions 9 to connect the engagement target part 6 and the corresponding part 8. Further, the engagement component temporary engagement unit 70 is positioned above one of the plurality of picking socket members 57 that is picking one of the plurality of bolts 4.

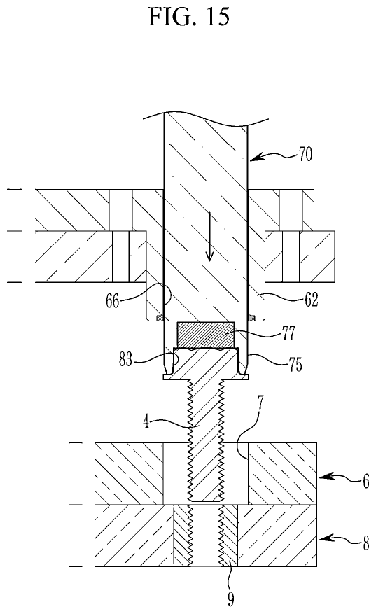

Then, as shown in FIG. 15, the engagement component temporary engagement unit 70 is moved in the downward direction. Accordingly, the runner socket member 75 of the engagement component temporary engagement unit 70 is moved through the runner body 73 in the downward direction.

Thus, a lower portion of the runner socket member 75 is inserted into the socket hole 66 of the socket body portion 62. One head of the plurality of bolts 4 is attached to the second magnet member 77 while being fixed to the engagement component fixing groove 83 of the runner socket member 75.

As described above, one of the plurality of bolts 4, fixed to the runner socket member 75, is positioned on one of the second engagement portions 9 of the corresponding part 8 through one of the plurality of first engagement portions 7 of the engagement target part 6, while being erected upright by the movement of the runner socket member 75.

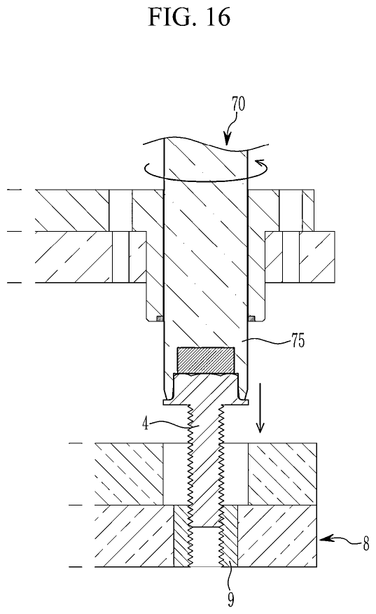

In this state, as shown in FIG. 16, the runner body 73 is rotated together with the runner socket member 75. Then, one of the plurality of bolts 4 is temporarily engaged to one of the plurality of second engagement portions 9 of the corresponding part 8 by the runner socket member 75.

Then, the engagement component temporary engagement unit 70 is returned to its original position and the magazine plate 55 is rotated by an interval of the plurality of picking socket members 57. Therefore, the plurality of bolts 4 may be temporarily engaged to the plurality of second engagement portions 9 of the corresponding part 8 through a series of processes as described above.

The engagement component supplying apparatus 100, according to an embodiment of the present disclosure, may pick a plurality of engagement components 3, including a plurality of bolts 4 simultaneously, and may supply the engagement target part 6 and the corresponding part 8 to be engaged to each other.

Therefore, the engagement component supplying apparatus 100, according to an embodiment of the present disclosure, may improve assembly productivity of the assembly component 1. Furthermore, the engagement component supplying apparatus 100 may reduce cost in the investment of equipment and equipment install area by supplying the plurality of engagement components 3 to the engagement target part 6 and the corresponding part 8 at high speed.

In addition, the engagement component supplying apparatus 100, according to an embodiment of the present disclosure, may supply and engage temporarily the plurality of engagement components 3 to the engagement target part 6 and the corresponding part 8 in a stable posture, thereby improving assembly quality of the assembly component 1.

Furthermore, the engagement component supplying apparatus 100, according to an embodiment of the present disclosure, may secure flexible productivity in assembling the multi-model assembly components 1.

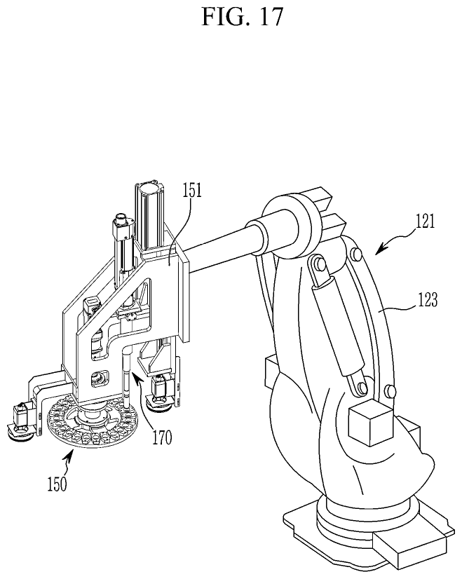

FIG. 17 is a drawing schematically illustrating an exemplary variation of the driving unit applied to the engagement component supplying apparatus according to an embodiment of the present disclosure.

Referring to FIG. 17, at least one driving unit 121 may include a handling robot 123.

The handling robot 123 is installed on the floor of the process workshop. The handling robot 123 may include a multi-joint robot operating along a predetermined teaching path within a working radius, which is known to a person of ordinary skill in the art.

An engagement component picking unit 150 and an engagement component temporary engagement unit 170 may be mounted on the arms of the handling robot 123 through a mounting bracket 151.

While the inventive concept of this disclosure has been described in connection with what are presently considered to be practical embodiments, it should be understood that the disclosure is not limited to the disclosed embodiments. On the contrary, tis disclosure is intended to cover various modifications and equivalent arrangements included within the spirit and scope of the appended claims.

### DESCRIPTION OF SYMBOLS

1: Assembly component
3: Engagement component
4: Bolt
6: Engagement target part
7: First engagement portion
8: Corresponding part
9: Second engagement portion
10: Jig frame
11: Base frame
13: Vertical frame
15: Horizontal frame
17: Part supporting portion
21, 121: Driving unit
22, 23, 24: Rail
25: First servo motor
27: Second servo motor
30: engagement component alignment unit
31: Parts feeder
32: Feeder frame
33: Line feeder
35: Engagement component index
36: Post
37: Mounting plate
41: Fixing member
42: Connection groove
43: Rotating member
45: Third servo motor
47: Engagement component alignment groove
50, 150: Engagement component picking unit
51, 151: Mounting bracket
53: Fourth servo motor
55: Magazine plate
57: Picking socket member
59: First magnet member
61: Rotation shaft
62: Socket body portion
63: Fifth servo motor
64: Socket fixing portion
65: Socket mount hole
66: Socket hole
70, 170: Engagement component temporary engagement unit
71: Moving member
73: Runner body
75: Runner socket member
77: Second magnet member
79: Sixth servo motor
81: Air motor
83: Engagement component fixing groove
100: Engagement component supplying apparatus
123: Handling robot

What is claimed is:

1. An engagement component supplying apparatus, comprising:
a jig frame in which at least one driving unit is installed, and configured to support an engagement target part and a corresponding part to be engaged to each other through a plurality of engagement components;
an engagement component picking unit installed on the at least one driving unit through a mounting bracket, and configured to pick the plurality of engagement components aligned at a predetermined position; and
an engagement component temporary engagement unit installed on the mounting bracket, and configured to, while picking the plurality of engagement components picked by the engagement component picking unit one by one, temporarily engage the plurality of engagement components to a plurality of second engagement portions of the corresponding part through a plurality of first engagement portions of the engagement target part.

2. The engagement component supplying apparatus of claim 1, further comprising:
an engagement component alignment unit coupled to the jig frame and configured to align the plurality of engagement components at a predetermined position.

3. The engagement component supplying apparatus of claim 2, wherein the engagement component alignment unit comprises:
at least one parts feeder configured to feed the plurality of engagement components along a predetermined path; and
an engagement component index connected to the at least one parts feeder and configured to align the plurality of engagement components.

4. The engagement component supplying apparatus of claim 3, wherein the engagement component index comprises:
a ring-shaped fixing member connected to a line feeder of the at least one parts feeder; and
a disk-shaped rotating member rotatably installed on the fixing member by a servo motor and having a plurality of engagement component alignment grooves connected to the line feeder formed on its edge to be spaced apart from each other.

5. The engagement component supplying apparatus of claim 1, wherein the at least one driving unit comprises
a plurality of rails extending in a front-rear direction, a left-right direction, and a vertical direction, respectively.

6. The engagement component supplying apparatus of claim 5, wherein
the mounting bracket is installed movably in the vertical direction on one rail,
the one rail is installed movably in the left-right direction on another rail, and
the other rail is installed movably in the front-rear direction on a pair of other rails.

7. The engagement component supplying apparatus of claim 1, wherein the engagement component picking unit comprises:
a disk-shaped magazine plate rotatably installed on the mounting bracket; and
a plurality of picking socket members mounted at least in a row to be spaced apart from each other on the magazine plate along its edge.

8. The engagement component supplying apparatus of claim 7, wherein the magazine plate comprises:
a plurality of socket mounting holes formed to be spaced apart from each other at least in a row along its edge.

9. The engagement component supplying apparatus of claim 8, wherein each of the plurality of picking socket members is mounted in each of the plurality of socket mounting holes and has a socket hole formed in a vertical direction.

10. The engagement component supplying apparatus of claim 8, wherein each of the plurality of picking socket members comprises:
a socket body portion having a cylindrical shape which is inserted into each of the plurality of socket mounting holes in a vertical direction and in which a socket hole is formed; and
a socket fixing portion integrally connected to the top of the socket body portion and fixed to an upper surface of the magazine plate.

11. The engagement component supplying apparatus of claim 7, wherein the engagement component picking unit is provided in a ring shape, and further comprises a first magnet member fixed to an inner circumferential surface of each of the plurality of picking socket members.

12. The engagement component supplying apparatus of claim 7, wherein the engagement component temporary engagement unit comprises:
a moving member installed movably in a vertical direction on the mounting bracket;
a runner body rotatably installed on the moving member; and
a runner socket member installed on the runner body so as to penetrate each of the plurality of picking socket members in the vertical direction.

13. The engagement component supplying apparatus of claim 12, wherein the engagement component temporary engagement unit further comprises a second magnet member installed inside the runner socket member.

14. The engagement component supplying apparatus of claim 1, wherein the at least one driving unit comprises a handling robot.

15. The engagement component supplying apparatus of claim 1, wherein the plurality of engagement components comprises a plurality of bolts.
